(19) United States
(12) Patent Application Publication
(10) Pub. No.: US 2025/0187099 A1
(43) Pub. Date: Jun. 12, 2025

(54) MOBILE FLASH-BUTT WELDING OF RAIL USING BATTERY POWER SOURCED SYSTEM AND METHODS OF USING THE SAME

(71) Applicant: Holland, L.P., Crete, IL (US)

(72) Inventors: Shane A. Mayhill, Crete, IL (US); Eric Wright, Peotone, IL (US); Nicholas G. Martino, Crete, IL (US)

(21) Appl. No.: 18/776,693

(22) Filed: Jul. 18, 2024

Related U.S. Application Data
(60) Provisional application No. 63/527,448, filed on Jul. 18, 2023.

(51) Int. Cl. B23K 11/04

(52) U.S. Cl. CPC B23K 11/043

(57) ABSTRACT

An improved mobile electric flash-butt welding system for repair and/or replacement of railway track provides a more energy-efficient and environmentally safe system for welding rail. The present invention replaces a traditional diesel powered AC power source with a DC battery system and a pulsed frequency converter system to generate an optimal flash-butt welding power source to melt and forge parent rail sections into a continuous rail system.

### CROSS-REFERENCE TO RELATED APPLICATIONS

The present invention claims priority to U.S. Prov. Pat. App. No. 63/527,448, titled “Mobile flash-Butt Welding of Rail Using Battery Power Sourced System and Methods of Using the Same,” filed Jul. 18, 2023, which is incorporated herein by reference in its entirety.

### TECHNICAL FIELD

The present invention relates to an improved mobile electric flash-butt welding system for repair and/or replacement of railway track. Specifically, the present invention provides a more energy-efficient and environmentally safe system for welding rail. The present invention replaces a traditional diesel powered AC power source with a DC battery system and a pulsed frequency converter system to generate an optimal flash-butt welding power source to melt and forge parent rail sections into a continuous rail system.

### BACKGROUND

Repairing and replacing sections of railroad trackwork has become increasingly difficult especially for railroad track that is in service due to increasing traffic requirements resulting in the need for smaller windows for scheduling repairs between trains. Specifically, it is difficult to move a typical AC-powered welding system to repair a track in the field due to increasing railway traffic issues. To repair a section of rail, the track typically requires shutdown for the period of repair. Typically, repair requires a pre-weld preparation stage, a welding stage, and post-weld grinding and spiking steps necessary to restore the track to service.

A need, therefore, exists for an improved rail welding system. Specifically, a need exists for an improved rail welding system that is more efficient than typical welding systems to allow the welding system to repair the rail as quickly and efficiently as possible.

Moreover, typical mobile welding systems utilize the gas or diesel engine of the mobile vehicle or another gas or diesel generator to provide AC power for the welding system. A transformer typically steps down the AC power generated by the diesel powered AC generator to a low voltage, high current source to produce the arc, which is applied to a controlled gap between two sections of rail. The AC arcing process is generally controlled via an intelligent monitoring system that varies the space between the rail sections and varies the current throughout the weld cycle to produce a high performance weld. The weld typically takes less than 10 minutes to produce.

Prior to the welding, there are typically track preparation steps and post weld there are grinding and spiking steps necessary to restore the track to service. The gas or diesel generator generating the AC power for the welds typically runs continuously during the pre- and post-operations. Moreover, the diesel generator typically runs continuously as the mobile vehicle travels from repair location to repair location. Fuel is consumed during these times even if power is not produced for weld production. Often, because more fuel is necessary than just used for weld production, large, heavy, and bulky vehicles are required to transfer the fuel requirements to the repair locations.

A need, therefore, exists for an improved rail welding system that reduces the consumption of fuel. Consequently, a need exists for an improved rail welding system that reduces the size and weight of mobile vehicles thereby contributing to the reduction of fuel consumption. More specifically, a need exists for an improved rail welding system that decreases environmental harm caused by unnecessary fuel consumption.

Flash-butt welding of metals can use DC voltage and current to directly drive welding systems and generate welds. However, in railroad applications, DC powered welding systems can damage DC powered communication signals for monitoring rail and controlling crossing gates and other like functional systems. Therefore, DC-based welding systems are typically not used in railroad rail repair or maintenance.

A need, therefore, exists for improved rail welding systems that utilize a DC power source. Specifically, a need exists for improved rail welding systems that utilize a DC power source to repair rails that do not interfere with DC powered communication signals that are used to monitor rail and control crossing gates and other functional systems.

### SUMMARY OF THE INVENTION

The present invention relates to an improved mobile electric flash-butt welding system for repair and/or replacement of railway track. Specifically, the present invention provides a more energy-efficient and environmentally safe system for welding rail. The present invention replaces a traditional diesel powered AC power source with a DC battery system and a pulsed frequency converter system to generate an optimal flash-butt welding power source to melt and forge parent rail sections into a continuous rail system.

To this end, in an embodiment of the present invention, a welding system for welding railroad rails is provided. The welding system comprises an energy storage system, a DC conversion module that converts DC energy into pulsed AC-like power; and a welding control system comprising step down transformers for producing low voltage, high current AC-like power for use in a welding operation. In an embodiment, the energy storage system is a battery bank. More specifically, the battery bank is a lithium battery bank. Moreover, in an embodiment, the DC conversion module is an insulated gate bipolar transistor system. In addition, in an embodiment, the welding operation is a flash-butt welding operation.

It is, therefore, an advantage and objective of the present invention to provide an improved rail welding system.

More specifically, it is an advantage and objective of the present invention to provide an improved rail welding system that is more efficient than typical welding systems to allow the welding system to repair the rail as quickly and efficiently as possible.

In addition, it is an advantage and objective of the present invention to provide an improved rail welding system that reduces the consumption of fuel.

Consequently, it is an advantage and objective of the present invention to provide an improved rail welding system that reduces the size and weight of mobile vehicles thereby contributing to the reduction of fuel consumption.

More specifically, it is an advantage and objective of the present invention to provide an improved rail welding system that decreases environmental harm caused by unnecessary fuel consumption.

Further, it is an advantage and objective of the present invention to provide an improved rail welding system that utilizes a DC power source.

Specifically, it is an advantage and objective of the present invention to provide an improved rail welding system that utilizes a DC power source to repair rails that do not interfere with DC powered communication signals that are used to monitoring rail and controlling crossing gates and other systems.

Additional features and advantages of the present invention are described in, and will be apparent from, the detailed description of the presently preferred embodiments and from the drawings.

### BRIEF DESCRIPTION OF THE DRAWINGS

The drawing FIGURES depict one or more implementations in accord with the present concepts, by way of example only, not by way of limitations. In the FIGURES, like reference numerals refer to the same or similar elements.

FIG. 1 illustrates a flowchart illustrating a system and method for powering a flash-butt welding operation on railroad rails using a DC power source in an embodiment of the present invention.

### DETAILED DESCRIPTION OF THE PRESENTLY PREFERRED EMBODIMENTS

The present invention relates to an improved mobile electric flash-butt welding system for repair and/or replacement of railway track. Specifically, the present invention provides a more energy-efficient and environmentally safe system for welding rail. The present invention replaces a traditional diesel powered AC power source with a DC battery system and a pulsed frequency converter system to generate an optimal flash-butt welding power source to melt and forge parent rail sections into a continuous rail system.

The present invention utilizes a unique DC battery powered system along with a DC pulse control system that creates a simulated alternating power source (an “AC-like” power source) that may be varied through an intelligent control system to produce a power source that achieves the same for improved weld performance.

Specifically, the system comprises a DC battery bank, such as a lithium battery pack or other similar battery bank that may be useful. The DC power from the battery bank may be converted to a series of pulses using an insulated gate bipolar transistor system (“IGBT”). The pulses may be controlled via step down transformers to create an AC-like low voltage, high current source for the arcing across a controlled gap, such as may be found on a rail requiring repair. The DC battery bank may be recharged between weld cycles via a small generator driven by the mobile vehicle engine that may always be running, via a solar panel system on the mobile vehicle, via a larger electric vehicle battery system that has a higher charge capacity, via fuel cell power system, or via any other means for recharging the battery bank.

Preferably, the system of the present invention takes a relatively low current power source, which may be AC or DC, to charge a battery bank with a high energy density that may store power between welds. The battery's stored power is then converted via an IGBT (or other similar DC to AC or pulsed switching technology, as apparent to one of ordinary skill in the art) and step down transformers to produce a pulsed low voltage, high current arc to melt the rail ends prior to forge upset. The pulsed power source protects DC communication systems and is ideal for controlling the arcing process via changes in frequency thereof for more uniform heating of the complex rail geometry.

The system of the present invention reduces the weight of the power systems by replacing the large, high powered generator with added fuel storage required with a smaller, lighter weight battery pack and step down transformers. The invention reduces fuel consumption by not having the generator consume fuel between welding cycles. This may also reduce carbon emissions by reducing the need to run the generator at all times. Smaller footprint units may allow for a shorter mobile unit that may allow for easier setting on track at smaller grade crossings, for example. Pulsed power energy sources may provide an opportunity to vary frequency through the track welding cycle, which may offer more control over the heating process of the welding cycles.

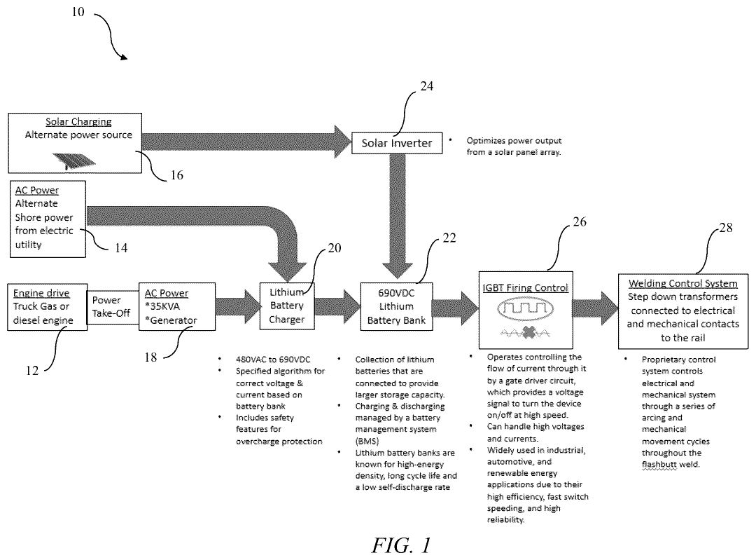

In an embodiment of the present invention, FIG. 1 illustrates a flowchart 10 showing an exemplary system and method for powering a flash-butt welding unit for use for the welding of railroad rails. The flowchart 10 illustrates three possible power sources, namely an engine drive 12, such as a truck gas or diesel engine or a generator 18, an alternate shore power source 14, which may provide AC power from an electric utility, and/or a solar panel unit power source 16. Of course, any other power source may be utilized and the present invention should not be limited as described herein.

If the power source is AC powered, such as from the truck gas or diesel engine (12) or other like generator (18), or from shore power from an electric company (14), the AC power may be converted to DC power via lithium battery charger 20. For example, the lithium battery charger may take 480 VAC and convert to 690 VDC but utilizing specific algorithms for converting the AC power to the correct DC power for storage in a battery bank 22. Preferably, the battery bank 22 may be a 690 VDC lithium battery bank, which may be a collection of lithium batteries connected to form a relatively large storage capacity. Lithium battery banks may be used due to their high energy density, long cycle life, and low self-discharge rate. Of course, other types of battery banks may be utilized and the present invention should not be limited as described herein. The battery bank 22 may be charged and/or discharged using a battery management system (BMS).

Alternatively, the battery bank may be charged via a solar panel unit 16, as described above, which may be converted to the proper DC power via a solar inverter 24, which may optimize the power output from the solar unit 16 for charging the battery bank 22.

In any case, whether the power source is AC power or DC power, the battery bank 22 may be charged and power stored therein may be utilized for flash-butt welding, as described hereinbelow. In an embodiment, a protective automatic discharge disconnect may be positioned between the power source, preferably between the AC power source, and the battery bank 22 to protect the power source and the overall charging system from power surges that may feedback that are generated by the flash-butt welding system described below. Moreover, the automatic discharge disconnect may help to isolate and protect the flash-butt welding system circuitry that utilizes the battery bank from the power source.

Specifically, the DC power from the battery bank 22 may be converted to a series of pulses using an IGBT firing control system 26. The IGBT may operate to provide a voltage signal that may turn the welder on and off at high speeds, effectively converting the DC power to pulsed AC-like power, which may be sent to the welding control system for powering the welder. Specifically, a welding control system 28 may utilize one or more step down transformers to convert the pulsed AC-like power to low voltage, high current AC-like pulsed power to power the flash-butt welder.

The welding control system 28 may further be used to specifically control the frequency of the resultant AC-like pulsed power, thereby providing precise arcing and/or melting control in a flash-butt welding operation.

Thus, power required for the flash-butt welding operation is only used when demanded from the battery bank 22. The power sources 12, 14, 16 may be utilized to charge the battery bank, which may occur at any time. Therefore, the use of the battery bank 22 to source power through the IGBT Firing Control 26 to weld railroad track via the welding control system 28 may be very efficient because the power draw is only required when the welding unit is operational, drawing power only when needed from the battery bank 22. Thus, if the battery bank 22 is sufficiently charged, AC or DC power sources 12, 14, 16 for charging the battery bank 22 are not needed and may be discontinued. Moreover, the AC or DC power sources 12, 14, 16 may be activated only when needed to charge the battery bank 22.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A welding system for welding railroad rails comprising:
an energy storage system;
a DC conversion module that converts DC energy into pulsed AC-like power; and
a welding control system comprising step down transformers for producing low voltage, high current AC-like power for use in a welding operation.

2. The welding system of claim 1 wherein the energy storage system is a battery bank.

3. The welding system of claim 2 wherein the battery bank is a lithium battery bank.

4. The welding system of claim 1 wherein the DC conversion module is an insulated gate bipolar transistor system.

5. The welding system of claim 1 wherein the welding operation is a flash-butt welding operation.
